(19) United States
(12) Patent Application Publication
(10) Pub. No.: US 2023/0081276 A1
(43) Pub. Date: Mar. 16, 2023

(54) AN AUTOMATED GAMING ARRANGEMENT

(71) Applicant: TANGIAMO TOUCH TECHNOLOGY AB, Göteborg (SE)

(72) Inventors: Linh THAI, Göteborg (SE); Harald BÖRSHOLM, Göteborg (SE); Anton BENGTSSON, Hovås (SE)

(73) Assignee: TANGIAMO TOUCH TECHNOLOGY AB, Göteborg (SE)

(21) Appl. No.: 17/801,294

(22) PCT Filed: Feb. 26, 2021
(86) PCT No.: PCT/SE2021/050161

§ 371 Date: Aug. 22, 2022

(30) Foreign Application Priority Data
Feb. 28, 2020 (SE) 2050223-3

(51) Int. Cl. G07F 17/32

(52) U.S. Cl. CPC G07F 17/3267; G07F 17/3206; G07F 17/3211; G07F 17/3216

(57) ABSTRACT

The present disclosure generally relates to an automated gaming arrangement, specifically provided with means for reducing the need of continuous human surveillance. The present disclosure also relates to a corresponding method for operating such a gaming arrangement and a thereto related computer program product.

### TECHNICAL FIELD

The present disclosure generally relates to an automated gaming arrangement, specifically provided with means for reducing the need of continuous human surveillance. The present disclosure also relates to a corresponding method for operating such a gaming arrangement and a thereto related computer program product.

### BACKGROUND

Traditional games involving the use of one or a plurality of dice are well known. Also in the gambling environment, such as in a casino where games may be played for money, a multitude of different games are available in which different types of dice or similar gambling devices are used. Generally, one or a plurality of dice are rolled or shaken, and players are, under the supervision of one or more dealers, allowed to wager money on the outcome against each other or the bank.

In order to improve such a game, and possibly removing the need for a dealer(s), various dice game machines have been proposed in which the outcome of the throw of the dice is automatically determined by means of a camera and a control unit adapted to perform an image recognition algorithm on the images captured by the camera for recognizing the upward facing symbols of the die.

An example of such a dice game machine is disclosed in U.S. Pat. No. 7,361,090, for example describing a method including the steps of shaking multiple dice by a dice-shaking device in an opaque cap, recognizing pips on the dice with a detecting device, predicting numbers and placing stakes by players through player-interfaces, calculating scores of the players by a central control device, revealing the pips on the dice to the players by removing the opaque cap and showing the scores of the players on displays of the separate player-interfaces.

The method according to U.S. Pat. No. 7,361,090 is specifically suitable for fully automating the well-known dice game “Sic Bo” (also sometimes referred to as “Cussec”, “Tai Sai”, “Dai Siu”, “Big and Small” or “Hi-Lo”), and thereby possibly increasing the security of the gaming environment for both the casino and the players of the game. For example, as generally no dealer(s) are present, no possible error may be introduced due to a human mistake.

Even though the solution presented in U.S. Pat. No. 7,361,090 increases the security of the gaming environment for both the casino and the players of the game, there will still be needed some sort of human supervision to ensure that the game is progressing with a desired and high level of integrity. The solution presented in U.S. Pat. No. 7,361,090 is not suitable for use in a fully automated gaming environment. With the above in mind, there appears to be further improvements, specifically when moving towards a truly automated gaming environment without the need of human surveillance.

### Summary of the Present Disclosure

According to an aspect of the present disclosure, the above is at least partly alleviated by an automated gaming arrangement, comprising an automated mechanical gaming machine adapted to generate a gaming outcome, the automated mechanical gaming machine comprising an actuator and driver circuitry connected to the actuator, an image sensor arranged in a vicinity of the automated mechanical gaming machine and adapted to acquire an image indicative of the gaming outcome, a first user interface, a first output interface adapted to present a representation of the gaming outcome to a first user of the automated gaming arrangement, a control unit arranged in communication with the automated mechanical gaming machine, the image sensor, the first user interface and the first output interface, and a housing, wherein the automated mechanical gaming machine, the image sensor, the first user interface and the first output interface are at least partly arranged within the housing, wherein the control unit is adapted to receive, from the first user interface, an indication of that the first user wants to play a game at the automated gaming arrangement, operate the driver circuitry of the automated mechanical gaming machine to control the actuator to generate the gaming outcome, operate the image sensor to acquire a first image indicative of the gaming outcome, determine a present gaming outcome based on the first image, if the present gaming outcome corresponds to a previous gaming outcome acquire a stored second image being indicative of a previous gaming outcome, determine a level of similarity between the first and the second image, compare the level of similarity with a first threshold, and present, at the first output interface, a representation of the present gaming outcome only if the present gaming outcome is different from the previous gaming outcome or the level of similarity is below the first threshold.

By means of the present disclosure, it is made possible to in an a truly automatic manner, and without using dedicated sensors integrated with the automated mechanical gaming machine, determine if there is a potential problem with the automated mechanical gaming machine. This is in line with the present disclosure achieved by comparing a presently acquired image visualizing a present gaming outcome, with a previously and in a corresponding manner acquired image visualizing the previously generated gaming outcome. The comparison is in accordance to the present disclosure implemented to form a measure of how well the images matches with each other, here represented with a level of similarity.

The level of similarity may in turn be compared to a first threshold, where the first threshold may be set to allow not only perfect matches to be determined as problematic and possibly relating to a problem with the automated mechanical gaming machine. Rather, the first threshold may be arranged to be slightly lower than representing a perfect match, such a e.g. in the range of e.g. 70-100 of a perfect matching, where a perfect match may be represented by e.g. 100 (such as a 100% match between the present and the previous image). As defined above, only in case the similarity level is below the first threshold then the representation of the gaming outcome is presented at the output interface.

An advantage following the preset disclosure is that it is possible to add an extra level of security to the automated gaming arrangement, as compared previously known implementation of automated gaming arrangements comprising an automated mechanical gaming machine. That is, the image processing scheme used in accordance to the present disclosure may be seen as an additional layer of protection for the owner of the automated gaming arrangement, reducing a possible risk with erroneous payments in case e.g. there is a potential problem with automated mechanical gaming machine. The disclosed image processing scheme may quickly identify in case the automated mechanical gaming machine starts to malfunction, such as in case the actuator and/or the driver circuitry connected to the actuator would start to have problem with performing its dedicated task in relation to the automated mechanical gaming machine.

However, to ensure that a user perceived waiting period between subsequent games is kept to a minimum it is desirable to perform the image comparison only selectively and in a hierarchical manner. Specifically, in accordance to the present disclosure the image comparison is only performed in case the present gaming outcome and the just previous gaming outcome has been determined to be the same.

The control unit may of course and in line with the present disclosure make use of images acquired using the image sensor for determining the actual gaming outcome, also using image processing strategies implemented at the control unit. Such image processing strategies for determining the gaming outcome may for example involve implementing an image recognition algorithm on the images captured by the image sensor for e.g. recognizing an upward facing symbol of a component of the automated mechanical gaming machine, such as for forming a random outcome to be used when playing the game at the automated gaming arrangement.

In one embodiment, the image comparison is performed by determining a center point for the upward facing symbol. As an example, in case the upward facing symbol is defined as an upward facing dice, then the center of all of the shown pips could be defined as such a center point. The comparison will then be individual for each upward facing symbol comprised with the gaming outcome.

In line with the above discussed hierarchical implementation, in case the center points are determined to be the same (for each of the upward facing symbols), then distinct features of each the upward facing symbol may be compared, i.e. present in comparison the just previously generated gaming outcome. As such, only the necessary amount of comparison is performed at each time, thus reducing the necessary waiting time for until when the user again may initiate the next game.

In some embodiments it may be possible to allow the determination of the actual gaming outcome to influence how to set the first threshold. For example, in case the gaming outcome for two consecutive “plays” is considered to be the same, then this may be used for increasing the first threshold towards (normalized) 100/100.

The image processing scheme according to the present disclosure may also be used for determining if the actuator and/or the driver circuitry connected to the actuator are not fully working as desired.

If for example the automated mechanical gaming machine is a dice-shaking device comprising one die of a plurality of dice, then the actuator may be adapted to operate a fluctuating surface (“wobbling”). In a situation where e.g. the fluctuating surface is not wobbling with its desired intensity/amplitude, then a prior art solution with a sensor arranged in relation to the surface may only be adapted to determine if or if not, the surface is fluctuating, but not the level of wobbling. The present disclosure may however be used for identifying how much the die/dice are “moving” and make use of this measure for determining if there is a problem with the dice-shaking device.

As an example, the image processing scheme in accordance with the present disclosure will be able to identify a situation where e.g. a first die has moved slightly and possibly even turned what side to be up, but e.g. a second and a third dice has stayed (almost) at its previous position. That is, the result has in fact changed, but the overall operation of the automated mechanical gaming machine is slightly “crippled”, meaning that the randomness of normally achieved by the automated mechanical gaming machine has changed (typically lowered). Such a change in the randomness would be highly advantageous for the user of the automated gaming arrangement, and at the same time highly disadvantageous for the owner of the automated gaming arrangement.

In previous situations, such as in relation to the previous use of e.g. dice-shaking devices provided with automated gaming arrangements, a human supervisor would have to regularly/continuously monitor the operation of the automated gaming arrangement and how the user is performing. For example, such a human supervisor would typically identify if the user is winning an unexpected amount of times at the automated gaming arrangement. Conversely, the implementation of the automated gaming arrangement in line with the present disclosure will allow for the gaming arrangement to be truly automated, meaning that the interaction by a human supervisor may be greatly reduced and/or possibly completely eliminated.

In accordance to the present disclosure, the expression “control unit” should be understood to include any type of computing device, such as an ASIC, a micro-processor, etc. It should also be understood that the actual implementation of such a processing circuitry may be divided between more than a single device/circuit.

Furthermore, the expressions “drive circuitry” and “actuator” should be interpreted broadly and will of course depend on the selection of the automated mechanical gaming machine. As indicated above, in some embodiments the automated mechanical gaming machine may be a dice-shaking device. However, in line with the present disclosure also other forms of automated mechanical gaming machines are possible, such as including a roulette wheel or a playing card shuffler.

Similarly, the expression “first user interface” should be interpreted broadly and may include any form of e.g. button or similar that may be used for allowing the user to interact with information about a game, defined as gaming information, possibly in turn being part of the information being displayed at the first output interface together with the gaming outcome. Thus, also the expression “first output interface” should be interpreted broadly and may include any form of e.g. light sources, one or a plurality of display screens, etc. As an example, the game may be a Sic Bo game, a roulette game or a card game. Other type of games may of course be possible and are within the scope of the present disclosure.

In some embodiments it may be possible to allow the housing to comprise a compartment adapted to receive the automated mechanical gaming machine, and the automated gaming arrangement further comprises a first screen arranged at the compartment for allowing the user to in a first state view but not touch the automated mechanical gaming machine. In the simplest implementation the first screen is e.g. a piece of transparent glass or plastic.

However, it may in another embodiment be desirable to use a first screen that is arranged to be transparent in the first state and opaque in a second state, such as is the case with e.g. a liquid-crystal element. By arranging the screen in the second state it may as such be possible to allow the automated mechanical gaming machine to “hidden” during a portion of the game played at the automated gaming arrangement. In one embodiment the first screen is arranged in the second state until the image processing scheme according to the present disclosure has determined that the similarity level is below the first threshold.

In some embodiments the first screen is a transmissive display screen. As such, the screen could in some situations be used for e.g. presenting the first output interface. In some embodiments such a transmissive screen may form part of the first input interface and/or the first output interface.

Advantageously, the user interface is adapted to also be operated by a second user. For example, the first user interface may in some embodiments be adapted to sequentially receive a gaming input from each of the first and the second user. This will allow for more than a single player/user to operate the automated gaming arrangement.

In another possible implementation of the automated gaming arrangement may also be provided with a second user interface adapted to receive a gaming input from the second user. For example, the compartment may in such an implementation be adapted to be viewable from a first and a second main direction, the first screen arranged in relation to the first main direction and provided with a second screen arranged in relation the second main direction. The second user interface may in such an implementation be provided in relation to the second screen, at least partly aligned with the second main direction.

The automated gaming arrangement is furthermore preferably provided with a mounting structure configured to receive the housing. The mounting structure may in turn comprises at least one of a wall-mount and a floor stand.

The automated gaming arrangement may further comprise a third user interface for receiving a payment from the user. Such a payment feature may for example be implemented using e.g. an RFID or NFC reader. However, it should be understood that also other means for payment is possible and within the scope of the present disclosure.

According to another aspect of the present disclosure, there is provided a method for operating an automated gaming arrangement, the automated gaming arrangement comprising an automated mechanical gaming machine adapted to generate a gaming outcome, the automated mechanical gaming machine comprising an actuator and driver circuitry connected to the actuator, an image sensor arranged in a vicinity of the automated mechanical gaming machine and adapted to acquire an image indicative of the gaming outcome, a first user interface, a first output interface adapted to present a representation of the gaming outcome to a first user of the automated gaming arrangement, a control unit arranged in communication with the automated mechanical gaming machine, the image sensor, the first user interface and the first output interface, and a housing, wherein the automated mechanical gaming machine, the image sensor, the first user interface and the first output interface are at least partly arranged within the housing, wherein the method comprises the steps of receiving, at the control unit and from the first user interface, an indication of that the first user wants to play a game at the automated gaming arrangement, operating, using the control unit, the driver circuitry of the automated mechanical gaming machine to control the actuator to generate the gaming outcome, operating, using the control unit, the image sensor to acquire a first image indicative of the gaming outcome, determining a present gaming outcome based on the first image, if the present gaming outcome corresponds to a previous gaming outcome acquiring, using the control unit, a stored second image being indicative of a previous gaming outcome, determining, using the control unit, a level of similarity between the first and the second image, comparing, using the control unit, the level of similarity with a first threshold, and presenting, using the control unit and the first output interface, a representation of the present gaming outcome only if the present gaming outcome is different from the previous gaming outcome or the level of similarity is below the first threshold. This aspect of the present disclosure provides similar advantages as discussed above in relation to the previous aspects of the present disclosure.

According to a further aspect of the present disclosure, there is provided a computer program product comprising a non-transitory computer readable medium having stored thereon computer program means operating an automated gaming arrangement, the automated gaming arrangement comprising an automated mechanical gaming machine adapted to generate a gaming outcome, the automated mechanical gaming machine comprising an actuator and driver circuitry connected to the actuator, an image sensor arranged in a vicinity of the automated mechanical gaming machine and adapted to acquire an image indicative of the gaming outcome, a first user interface, a first output interface adapted to present a representation of the gaming outcome to a first user of the automated gaming arrangement, a control unit arranged in communication with the automated mechanical gaming machine, the image sensor, the first user interface and the first output interface, and a housing, wherein the automated mechanical gaming machine, the image sensor, the first user interface and the first output interface are at least partly arranged within the housing, wherein the computer program product comprises code for receiving, at the control unit and from the first user interface, an indication of that the first user wants to play a game at the automated gaming arrangement, code for operating, using the control unit, the driver circuitry of the automated mechanical gaming machine to control the actuator to generate the gaming outcome, code for operating, using the control unit, the image sensor to acquire a first image indicative of the gaming outcome, code for determining a present gaming outcome based on the first image, code for acquiring, using the control unit, a stored second image being indicative of a previous gaming outcome, wherein the stored second image is only acquired if the if the present gaming outcome corresponds to a previous gaming outcome, code for determining, using the control unit, a level of similarity between the first and the second image, code for comparing, using the control unit, the level of similarity with a first threshold, and code for presenting, using the control unit and the first output interface, a representation of the present gaming outcome only if the present gaming outcome is different from the previous gaming outcome or the level of similarity is below the first threshold. Also this aspect of the present disclosure provides similar advantages as discussed above in relation to the previous aspects of the present disclosure.

A software executed by the control unit for operating the inventive system may be stored on a computer readable medium, being any type of memory device, including one of a removable nonvolatile random-access memory, a hard disk drive, a floppy disk, a CD-ROM, a DVD-ROM, a USB memory, an SD memory card, or a similar computer readable medium known in the art.

Further features of, and advantages with, the present disclosure will become apparent when studying the appended claims and the following description. The skilled addressee realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawing, in which:

FIGS. 1A-1C presents a set of illustrations of a first embodiment of the automated gaming arrangement according to the present disclosure,

FIG. 2A-2B provides a set of illustrations of a second embodiment of the automated gaming arrangement according to the present disclosure, and

FIG. 3 is a flowchart illustrating the operation of the automated gaming arrangement as shown in FIG. 1A.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness, and fully convey the scope of the present disclosure to the skilled addressee. Like reference characters refer to like elements throughout.

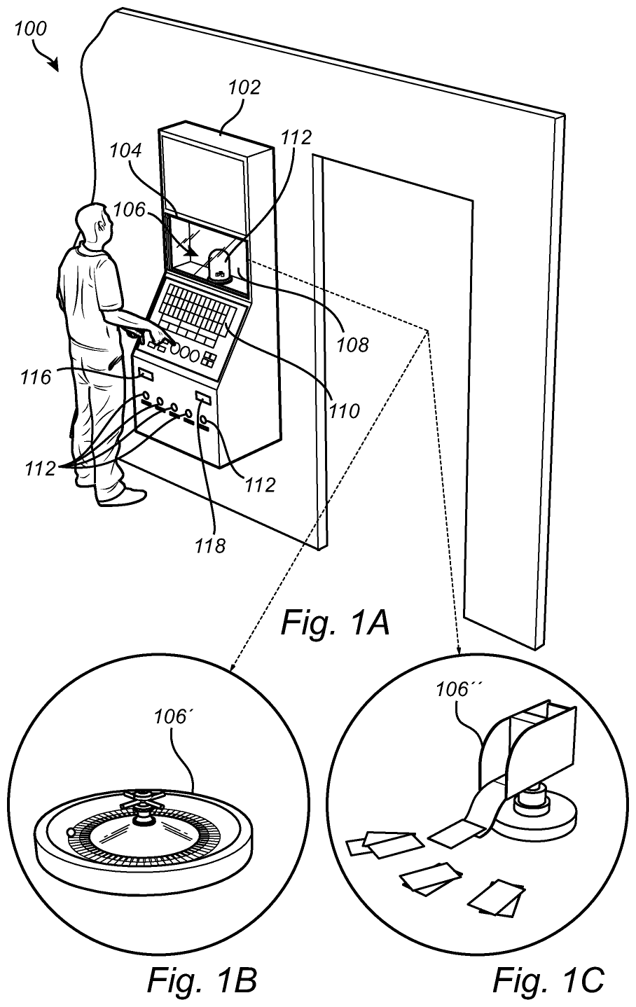

Referring now to the drawings and to FIG. 1A in particular, there is depicted an automated gaming arrangement 100, typically arranged at a gaming establishment, such as e.g. a casino or similar. The automated gaming arrangement 100 comprises a housing 102 provided with a compartment 104 adapted to receive an automated mechanical gaming machine, here in the form of a dice-shaking device 106. The compartment 104 is provided with a screen 108 to ensure that a user of the automated gaming arrangement 100 may see the dice-shaking device 106 but not touch the dice-shaking device 106, eliminating the possibility for the user to interfere with a gaming outcome formed by the dice-shaking device 106. In the illustration shown in FIG. 1A the screen 108 is a transparent plastic or glass substrate securely arranged at the compartment 104.

The automated gaming arrangement 100 further comprises a first user interface and a first output interface. In the illustration shown in FIG. 1A, a touch screen 110 is provided and adapted to implement a portion of both the first user interface and a first output interface. In FIG. 1A, the touch screen 110 is adapted to display a “Sic-Bo layout”, where the user/player may interact with the touch screen 110 for placing bets when playing the game.

As mentioned above, other type of games is possible and within the scope of the present disclosure. For example and as is exemplified in FIG. 1B, the automated mechanical gaming machine could in some embodiments comprise a roulette wheel 106′ or as shown in FIG. 1C a card shuffler 106″. Furthermore, the touch screen 110 may for example be adapted to display other layouts corresponding to the game to be played at the automated gaming arrangement 100, e.g. including a roulette layout and/or a card game layout.

It should be noted that it of course may be possible to provide further means, such as buttons, displays, light sources, for receiving input from and provide output to the user. As an example, in case more than a single user is to play a game at the automated gaming arrangement 100, each of the players may be instructed to sequentially interact with the automated gaming arrangement 100. In such an embodiment the automated gaming arrangement 100 may be provided with means 112 for indicating which of the plurality of users that is to now play the game. Possibly, such means may in some embodiments be integrated with the touch screen 110.

Additionally, the automated gaming arrangement 100 is provided with an image sensor and thereto related optics (not shown), where the image sensor is arranged in a vicinity of the dice-shaking device 106 and adapted to acquire an image indicative of the gaming outcome generated by the dice-shaking device 106, such as by implementing the mentioned image recognition algorithm on the images captured by the image sensor for recognizing the upward facing symbols of the die(s), such as the pips on the dice. In the implementation as shown in FIG. 1A, the image sensor is arranged “hidden” at a top surface of the compartment 108 and arranged to be facing down towards a top portion of the dice-shaking device 106. Other positions for the image sensor/optics is of course possible and within the scope of the present disclosure. It is generally preferred to make use of an image sensor that is adapted to capture images within the visible spectrum, thereby reducing the overall cost of implementation. Furthermore, making use of an image sensor that is adapted to capture images within the visible spectrum (as compared to an IR based camera), it is possible to identify distinct features from e.g. the dice, that are not visible in case of making use of an IR based camera.

Preferably, the optics provided with the image sensor may in some embodiments be selected to at least compensate from possible artifacts resulting from a transparent dome structure 114 comprised with the dice-shaking device 106, where the transparent dome structure 114 for example may be manufactured from glass and/or plastic.

The automated gaming arrangement 100 further comprises a control unit (not explicitly shown), where the control unit connected to the dice-shaking device 106, the touch screen 110 and the image sensor. For reference, the control unit may be manifested as a general-purpose processor, an application specific processor, a circuit containing processing components, a group of distributed processing components, a group of distributed computers configured for processing, a field programmable gate array (FPGA), etc. The processor may be or include any number of hardware components for conducting data or signal processing or for executing computer code stored in memory. The memory may be one or more devices for storing data and/or computer code for completing or facilitating the various methods described in the present description. The memory may include volatile memory or nonvolatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

Furthermore, in the exemplary illustration as shown in FIG. 1A, the automated gaming arrangement 100 further comprises a stand (not shown) for allowing the gaming machine 100 to be positioned at a wall of e.g. the mentioned gaming establishment. It should of course be understood that the stand may be implemented differently, allowing the automated gaming arrangement 100 to be positioned at e.g. a floor of the gaming establishment.

Still further, the automated gaming arrangement 100 may in some embodiments comprise means for allowing the user to make payments, such as using a card reader 116 implemented using any suitable technology, and optionally for allowing the user to receive payments, such as a e.g. a printer or a cash payment arrangement 118.

Additionally, the automated gaming arrangement 100 may in some embodiments be connected to a remotely located server (not shown), that may be used for handling reception of and provision of payment(s) from/to the user. Such a remotely arranged server could also, at least in part, be used for administrating the general operation of the automated gaming arrangement 100.

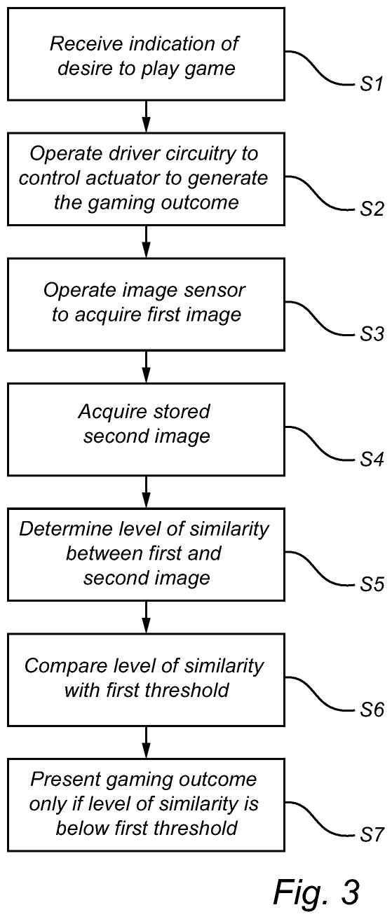

During operation of e.g. the automated gaming arrangement 100 as shown in FIG. 1A and with further reference to FIG. 3, the control unit receives, S1, from the touch screen 110, an indication of that the first user wants to play a game at the automated gaming arrangement 100.

The control unit will, following e.g. the reception of a payment from the user, operate, S2, the driver circuitry of the dice-shaking device 106 to control a comprised actuator to generate the gaming outcome. As mentioned above, the actuator may be arranged in mechanical connection with a surface of the dice-shaking device 106, where the surface may be adapted to wobble once the actuator moves the wobbling surface of the dice-shaking device 106. The wobbling of the surface is preferably performed for a predetermined time period, such between 2-10 seconds, typically 6 seconds.

At least once the surface of the dice-shaking device 106 has stopped wobbling, the control unit operates, S3, the image sensor to acquire a first image indicative of the gaming outcome. The image may in some embodiments be “pre-edited” to only collect information as to an area corresponding to the wobbling surface.

The control unit is further adapted to acquire, S4, a stored second image being indicative of a previous gaming outcome. The second image may for example be stored with a memory element comprised with the control unit or arranged in communication with the control unit.

Once the control unit has access to both the first and the second image, it is possible to determine, S5, a level of similarity between the first and the second image. In some embodiments the comparison includes matching between the first and the second image. However, any form of scheme may be used for determining how well the first image corresponds to the second image. In some embodiments the level of similarity may be between 0 to 100, where 0 represents no match and 100 represents a full match.

The level of similarity is in turn compared, S6, to a first threshold. The first threshold may for example be fixed or dynamically set. When fixed, the first threshold could possibly set close to 100, such as above 90, to ensure that “only everything that really looks the same” is identified as a correspondence.

However, the first threshold may also be set dynamically. As an example, the first threshold could possibly be sequentially lowered from game to game. That is, it could be possible to allow the first threshold to initially be set high, such as above 90. If the similarity level then is determined to be close to the first threshold (below the first threshold but above a second threshold, where the second threshold is lower than the first threshold), then the first threshold may subsequently be lowered the next time the game is played. Using such an implementation it is possible to improve the overall robustness if the automated gaming arrangement 100, reducing the amount of false positively identified matching images.

Finally and only if the level of similarity is below the first threshold, the control unit controls the touch screen 110 to present, S7, a representation of the gaming outcome. Accordingly, in case the similarity level is above the first threshold, it may be possible to stop the game and refund the user before presenting the gaming outcome.

As discussed above, the control unit may typically also implement the image recognition algorithm on the first image captured by the image sensor for recognizing the upward facing symbols of the die(s), such as the pips on the dice, where the result of the image recognition algorithm may be seen as a representation of the gaming outcome. In some embodiments the determination of the gaming outcome is only performed in case the level of similarity level is below the first threshold. However, in some embodiments it may be desirable to perform the determination of the gaming outcome in parallel with determining level of similarity.

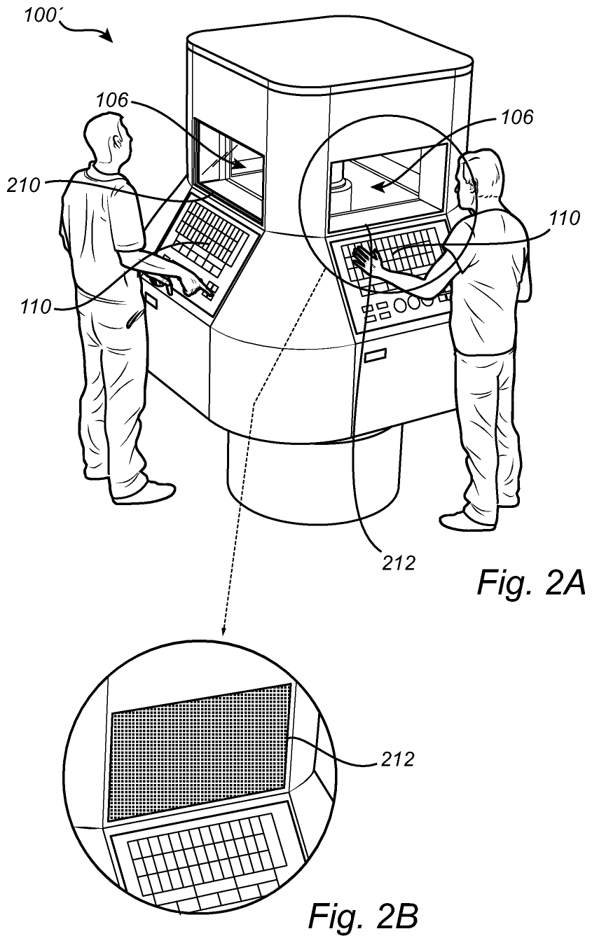

Turning now to FIG. 2A, presenting an alternative embodiment of an automated gaming arrangement 100′ arranged in line with the present disclosure. The automated gaming arrangement 100′ in many ways corresponds to the automated gaming arrangement 100 as shown in FIG. 1A, however here adapted to allow more than one user to play the game at the same time.

As such, the compartment 108 of the automated gaming arrangement 100′ is here arranged allow four different users/players to simultaneously from four sides view the dice-shaking device 106, from a first, a second, a third, and a fourth main direction. In the example shown in FIG. 2A, each of the four sides is provided with an individual screen, where only two screens 210, 212 are shown.

As compared to the automated gaming arrangement 100, the automated gaming arrangement 100′ is here provided with a screen that is adapted change between a first and a second state, where the screen 210, 212 is transparent in the first state and opaque in a second state. In line with the present disclosure, the screen 210, 212 may be arranged in the second (opaque) state as shown in FIG. 2B until e.g. the control unit of the automated gaming arrangement 100′ has decided a final gaming outcome of the dice-shaking device 106, and no further bets are allowed. Using the controllable screen 210, 212, it is possible to remove the necessity of the opaque cap as for example used in accordance to known prior art. The controllable screen 210, 212 are further advantageous since no elevating device is needed to remove the opaque cap, thereby reducing possible problems that may appear when including such a mechanical component. However, it may also in line with the present disclosure be possible to allow the screen 210, 212 to stay in the second state until the image processing scheme according to the present disclosure has decided that the level of similarity is below the first threshold.

In addition, the control functionality of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures may show a sequence the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art. Further, a single unit may perform the functions of several means recited in the claims. In the claims, any reference signs placed between parentheses shall not be construed as limiting to the claim. Furthermore, in the claims, the word “comprising” does not exclude other elements or steps, and the indefinite article “a” or “an” does not exclude a plurality.

Variations to the disclosed embodiments can be understood and effected by the skilled addressee in practicing the claimed present disclosure, from a study of the drawings, the disclosure, and the appended claims. The person skilled in the art realizes that the present disclosure is not limited to the preferred embodiments.

1. An automated gaming arrangement, comprising:
an automated mechanical gaming machine adapted to generate a gaming outcome, the automated mechanical gaming machine comprising an actuator and driver circuitry connected to the actuator,
an image sensor arranged in a vicinity of the automated mechanical gaming machine and adapted to acquire an image indicative of the gaming outcome,
a first user interface,
a first output interface adapted to present a representation of the gaming outcome to a first user of the automated gaming arrangement,
a control unit arranged in communication with the automated mechanical gaming machine, the image sensor, the first user interface and the first output interface, and
a housing, wherein the automated mechanical gaming machine, the image sensor, the first user interface and the first output interface are at least partly arranged within the housing,
wherein the control unit is adapted to:
receive, from the first user interface, an indication of that the first user wants to play a game at the automated gaming arrangement,
operate the driver circuitry of the automated mechanical gaming machine to control the actuator to generate the gaming outcome,
operate the image sensor to acquire a first image indicative of the gaming outcome,
determine a present gaming outcome based on the first image,
if the present gaming outcome corresponds to a previous gaming outcome:
acquire a stored second image being indicative of a previous gaming outcome,
determine a level of similarity between the first and the second image,
compare the level of similarity with a first threshold, and
present, at the first output interface, a representation of the present gaming outcome only if the present gaming outcome is different from the previous gaming outcome or the level of similarity is below the first threshold.

2. The automated gaming arrangement according to claim 1, wherein the housing comprises a compartment adapted to receive the automated mechanical gaming machine, and the automated gaming arrangement further comprises a first screen arranged at the compartment for allowing the user to in a first state view but not touch the automated mechanical gaming machine.

3. The automated gaming arrangement according to claim 2, wherein the first screen is transparent in the first state and opaque in a second state.

4. The automated gaming arrangement according to claim 3, wherein the first screen comprises a liquid-crystal element.

5. The automated gaming arrangement according to claim 2, wherein the first screen is a transmissive display screen.

6. The automated gaming arrangement according to claim 1, wherein the first user interface is adapted to be operated also by a second user.

7. The automated gaming arrangement according to claim 6, wherein the first user interface is adapted to sequentially receive a gaming input from each of the first and the second user.

8. The automated gaming arrangement according to claim 1, further comprising a second user interface adapted to receive a gaming input from a second user.

9. The automated gaming arrangement according to claim 2, wherein:
the compartment is adapted to be viewable from a first and a second main direction, the first screen in relation to the first main direction, and
the automated gaming arrangement further comprises a second screen arranged in relation the second main direction.

10. The automated gaming arrangement according to claim 1, wherein the automated mechanical gaming machine comprises at least one of a dice-shaking device, a roulette wheel or a playing card shuffler.

11. The automated gaming arrangement according to claim 1, wherein the game is a Sic Bo game, a roulette game or a card game.

12. The automated gaming arrangement according to claim 1, further comprising a mounting structure configured to receive the housing.

13. The automated gaming arrangement according to claim 12, wherein the mounting structure comprises at least one of a wall-mount and a floor stand.

14. The automated gaming arrangement according to claim 1, further comprising a third user interface receiving a payment from the first user.

15. The automated gaming arrangement according to claim 14, wherein the second user interface comprises an RFID reader or an NFC reader.

16. A method for operating an automated gaming arrangement, the automated gaming arrangement comprising:
an automated mechanical gaming machine adapted to generate a gaming outcome, the automated mechanical gaming machine comprising an actuator and driver circuitry connected to the actuator,
an image sensor arranged in a vicinity of the automated mechanical gaming machine and adapted to acquire an image indicative of the gaming outcome,
a first user interface,
a first output interface adapted to present a representation of the gaming outcome to a first user of the automated gaming arrangement,
a control unit arranged in communication with the automated mechanical gaming machine, the image sensor, the first user interface and the first output interface, and
a housing, wherein the automated mechanical gaming machine, the image sensor, the first user interface and the first output interface are at least partly arranged within the housing,
wherein the method comprises the steps of:
receiving, at the control unit and from the first user interface, an indication of that the first user wants to play a game at the automated gaming arrangement,
operating, using the control unit, the driver circuitry of the automated mechanical gaming machine to control the actuator to generate the gaming outcome,
operating, using the control unit, the image sensor to acquire a first image indicative of the gaming outcome,
determining a present gaming outcome based on the first image,
if the present gaming outcome corresponds to a previous gaming outcome:
acquiring, using the control unit, a stored second image being indicative of a previous gaming outcome,
determining, using the control unit, a level of similarity between the first and the second image,
comparing, using the control unit, the level of similarity with a first threshold, and
presenting, using the control unit and the first output interface, a representation of the present gaming outcome only if the present gaming outcome is different from the previous gaming outcome or the level of similarity is below the first threshold.

17. A computer program product comprising a non-transitory computer readable medium having stored thereon computer program means operating an automated gaming arrangement, the automated gaming arrangement comprising:
an automated mechanical gaming machine adapted to generate a gaming outcome, the automated mechanical gaming machine comprising an actuator and driver circuitry connected to the actuator,
an image sensor arranged in a vicinity of the automated mechanical gaming machine and adapted to acquire an image indicative of the gaming outcome,
a first user interface,
a first output interface adapted to present a representation of the gaming outcome to a first user of the automated gaming arrangement,
a control unit arranged in communication with the automated mechanical gaming machine, the image sensor, the first user interface and the first output interface, and
a housing, wherein the automated mechanical gaming machine, the image sensor, the first user interface and the first output interface are at least partly arranged within the housing,
wherein the computer program product comprises:
code for receiving, at the control unit and from the first user interface, an indication of that the first user wants to play a game at the automated gaming arrangement,
code for operating, using the control unit, the driver circuitry of the automated mechanical gaming machine to control the actuator to generate the gaming outcome,
code for operating, using the control unit, the image sensor to acquire a first image indicative of the gaming outcome,
code for determining a present gaming outcome based on the first image,
code for acquiring, using the control unit, a stored second image being indicative of a previous gaming outcome, wherein the stored second image is only acquired if the if the present gaming outcome corresponds to a previous gaming outcome,
code for determining, using the control unit, a level of similarity between the first and the second image,
code for comparing, using the control unit, the level of similarity with a first threshold, and
code for presenting, using the control unit and the first output interface, a representation of the present gaming outcome only if the present gaming outcome is different from the previous gaming outcome or the level of similarity is below the first threshold.
